(19) United States
(12) Patent Application Publication
(10) Pub. No.: US 2021/0010859 A1
(43) Pub. Date: Jan. 14, 2021

(54) OPTICAL MEASUREMENT SYSTEM AND METHOD OF MEASURING LIGHT EMITTED FROM MICRO DEVICE

(71) Applicant: MIKRO MESA TECHNOLOGY CO., LTD., APIA (WS)

(72) Inventor: Li-Yi CHEN, Tainan City (TW)

(21) Appl. No.: 16/508,323

(22) Filed: Jul. 11, 2019

(51) Int. Cl. G01J 3/02; G01J 3/28; G01J 3/32; G01J 3/10

(52) U.S. Cl. CPC G01J 3/0218; G01J 3/2803; G01J 3/0229; G01J 3/10; G01J 3/32

(57) ABSTRACT

An optical measurement system is provided. The optical measurement system includes an optical fiber and a photo detecting component. The optical fiber has a first end, a second end opposite to the first end, and an inner cavity recessed from the first end and is configured to accommodate a micro device. The photo detecting component is connected to the second end of the optical fiber and is configured to receive light propagating from the first end of the optical fiber.

### BACKGROUND

### Field of Invention

The present disclosure relates to an optical measurement system and a method of measuring light emitted from a micro device.

### Description of Related Art

The statements in this section merely provide background information related to the present disclosure and do not necessarily constitute prior art.

In recent years, micro devices have become popular in general and commercial lighting applications. As a size of one device continues to shrink down, new issues emerge. For example, in light measurement applications, one of the traditional light measurements may be performed by an integrating sphere including an optical component consisting of a hollow spherical cavity with its interior covered with a reflective/diffusive white coating, and with small holes for entrance and exit ports. However, for a micro size LED (e.g., a micro LED), an intensity of light emitted therefrom may be too small for traditional light measurement equipment or method to give a thorough and detailed analysis of lighting properties of the micro size LED.

### SUMMARY

According to some embodiments of the present disclosure, an optical measurement system is provided. The optical measurement system includes an optical fiber and a photo detecting component. The optical fiber has a first end, a second end opposite to the first end, and an inner cavity recessed from the first end and is configured to accommodate a micro device. The photo detecting component is connected to the second end of the optical fiber and is configured to receive light propagating from the first end of the optical fiber.

According to some embodiments of the present disclosure, a method of measuring light emitted from a micro device is provided. The method includes: accommodating the micro device in an inner cavity of an optical fiber in which the optical fiber has a first end and a second end opposite to the first end, and the inner cavity is recessed from the first end; and receiving and measuring light propagating from the first end to the second end by a photo detecting component connected to the second end.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a schematic cross-sectional view of an optical measurement system according to some embodiments of the present disclosure;

FIG. 1B is a schematic cross-sectional view of the optical measurement system according to some embodiments of the present disclosure;

FIG. 1C is a schematic enlarged cross-sectional view of a portion of the optical measurement system according to some embodiments of the present disclosure;

FIG. 2 is a schematic cross-sectional view of an optical measurement system according to some embodiments of the present disclosure;

FIG. 3 is a schematic enlarged cross-sectional view of a portion of an optical measurement system according to some embodiments of the present disclosure;

FIG. 4 is a schematic enlarged cross-sectional view of a portion of an optical measurement system according to some embodiments of the present disclosure;

FIG. 5 is a schematic enlarged cross-sectional view of a portion of an optical measurement system according to some embodiments of the present disclosure;

FIG. 6 is a schematic cross-sectional view of an optical measurement system according to some embodiments of the present disclosure; and

FIG. 7 is a schematic flow chart of a method of measuring light emitted from the micro device.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In various embodiments, the description is made with reference to figures. However, certain embodiments may be practiced without one or more of these specific details, or in combination with other known methods and configurations. In the following description, numerous specific details are set forth, such as specific configurations, dimensions, and processes, etc., in order to provide a thorough understanding of the present disclosure. In other instances, well-known semiconductor processes and manufacturing techniques have not been described in particular detail in order to not unnecessarily obscure the present disclosure. Reference throughout this specification to “one embodiment,” “an embodiment” or the like means that a particular feature, structure, configuration, or characteristic described in connection with the embodiment is included in at least one embodiment of the disclosure. Thus, the appearances of the phrase “in one embodiment,” “in an embodiment” or the like in various places throughout this specification are not necessarily referring to the same embodiment of the disclosure. Furthermore, the particular features, structures, configurations, or characteristics may be combined in any suitable manner in one or more embodiments.

The terms “over,” “to,” “between” and “on” as used herein may refer to a relative position of one layer with respect to other layers. One layer “over” or “on” another layer or bonded “to” another layer may be directly in contact with the other layer or may have one or more intervening layers. One layer “between” layers may be directly in contact with the layers or may have one or more intervening layers.

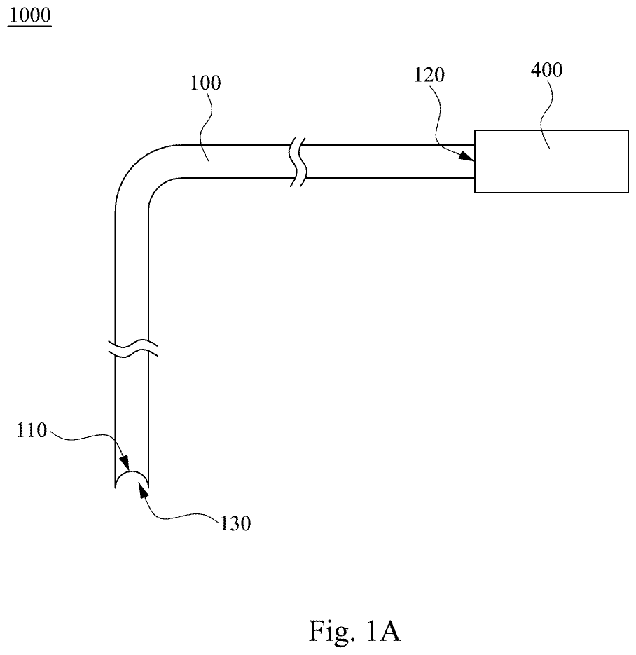

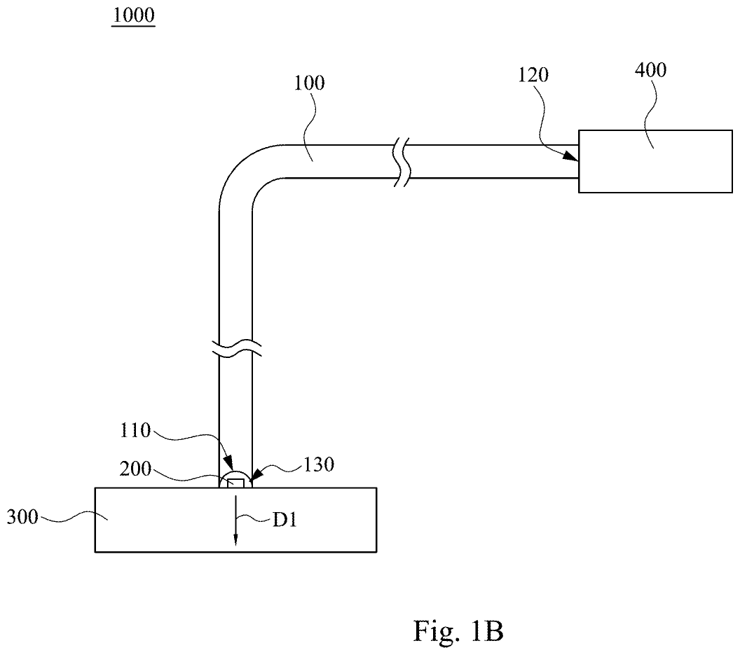

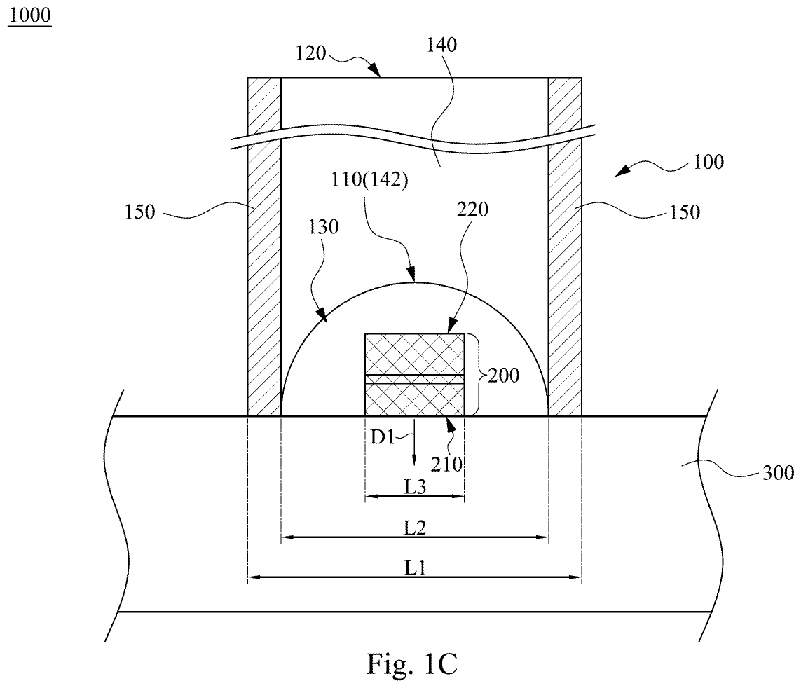

Reference is made to FIGS. 1A to 1C. FIGS. 1A and 1B are schematic cross-sectional views of an optical measurement system 1000 according to some embodiments of the present disclosure. FIG. 1C is a schematic enlarged cross-sectional view of a portion of the optical measurement system 1000 according to some embodiments of the present disclosure. In some embodiments, the optical measurement system 1000 includes an optical fiber 100 and a photo detecting component 400. The optical fiber 100 has a first end 110, a second end 120 opposite to the first end 110, and an inner cavity 130 recessed from the first end 110 (See FIGS. 1A and 1B). The inner cavity 130 is configured to accommodate a micro device 200 (see FIG. 1B). The micro device 200 has a first surface 210 and a second surface 220. When the micro device 200 is accommodated in the inner cavity 130, the first surface 210 is substantially facing away from the first end 110 (see FIG. 1C). The second surface 220 is opposite to the first surface 210 and facing toward the first end 110. Specifically, the “substantially facing away from the first end 110” is that the first surface 210 of the micro device 200 faces away from the optical fiber 100 in about a direction D1 as shown in FIG. 1C. Surfaces other than the first surface 210 of the micro device 200 (e.g., the second surface 220 or side surfaces (not explicitly indicated in figures) of the micro device 200) cannot be interpreted as “substantially facing away from the first end 110” since they all somewhat face toward the first end 110 of the optical fiber 100 (see FIG. 1C). In some embodiments, the micro device 200 is a micro light-emitting diode. The photo detecting component 400 is connected to the second end 120 of the optical fiber 100. The photo detecting component 400 is configured to receive light propagating from the first end 110 of the optical fiber 100.

In some embodiments, the optical fiber 100 includes a core portion 140 and a cladding layer 150. The cladding layer 150 wraps the core portion 140. The cladding layer 150 is configured to confine light to propagate within the core portion 140. In some embodiments, a refractive index of the cladding layer 150 is smaller than a refractive index of the core portion 140 so as to create a total reflection when the light propagates from the core portion 140 to the cladding layer 150. In some embodiments, the core portion 140 is made of fused silica, which can be etched to form the inner cavity 130. In some embodiments, the cladding layer 150 is made of silicon dioxide (SiO₂) or plastics, but should not be limited thereto. In some embodiments, the core portion 140 has a curved surface 142 at the first end 110 of the optical fiber 100. The curved surface 142 forms at least a part of the inner cavity 130. In general cases, the curved surface 142 of the core portion 140 is conformal to the first end 110 of the optical fiber 100. In some embodiments, a shape of the curved surface 142 is hemispherical.

In some embodiments, a lateral length L1 of the optical fiber 100 is greater than or equal to a lateral length L2 of the inner cavity 130. In some embodiments, a lateral length L3 of the micro device 200 is smaller than the lateral length L1 of the optical fiber 100. In some embodiments, the lateral length L3 of the micro device 200 is smaller than the lateral length L2 of the inner cavity 130. In some embodiments, the micro device 200 is a micro light-emitting device. In some embodiments, the lateral length L3 of the micro device 200 is smaller than or equal to about 100 μm. Each conditions or more than two conditions in combinations as mentioned above can be used to realize accommodating the micro device 200 into the inner cavity 130 of the optical fiber 100, so as to enhance the light collection from a single micro device 200 or to receive more light from the optical fiber 100 compared to a traditional method (structure) in which a flat surface of a traditional optical fiber is operated to be in proximity to a device under detection. It is noted that in the traditional method (structure) there is inevitably energy loss (intensity reduction) since a power received by the traditional optical fiber is inversely proportional to the square of a distance between a light-emitting device to be measured and the flat surface of the traditional optical fiber. The inner cavity 130 and the micro device 200 as mentioned in the above embodiments substantially avoid the above disadvantage regarding the energy loss since the micro device 200 are accommodated in the inner cavity 130 and substantially all of light emitted in the inner cavity 130 can be collected and transmitted through the core portion 140 of the optical fiber 100 and detected by the photo detecting component 400, and thus a signal to noise ratio is also enhanced compared to the traditional optical fiber. The embodiments as mentioned is especially useful for detecting light from the device with micro size (e.g., the micro device 200, particularly the micro light-emitting device) since an intensity of light emitted from a single micro light-emitting device is much smaller than a traditional light-emitting device, and thus it is much harder to make a detailed analysis of photoelectric characteristics of the single micro light-emitting diode. Furthermore, the embodiments as mentioned are not applicable to traditional light-emitting devices since the traditional light-emitting devices is too large to be put into the inner cavity 130 of the optical fiber 100 as mentioned. It is also not suitable to use an optical fiber with a diameter great enough to accommodate a conventional light-emitting diode since it will make the optical fiber (with greater diameter as mentioned) inconvenient to be manipulated (e.g., bending, but should not be limited thereto).

Reference is made to FIG. 1B. In some embodiments, the optical measurement system 1000 further includes a base portion 300 in contact with the first end 110. The micro device 200 is between the first end 110 and the base portion 300 when the micro device 200 is accommodated in the inner cavity 130. In some embodiments, the base portion 300 is in contact with the first surface 210 of the micro device 200. In some embodiments, the micro device 200 is enclosed by the first end 110 and the base portion 300. Specifically, the micro device 200 is fully packed or even sealed in the inner cavity 130 when the micro device 200 is accommodated in the inner cavity 130.

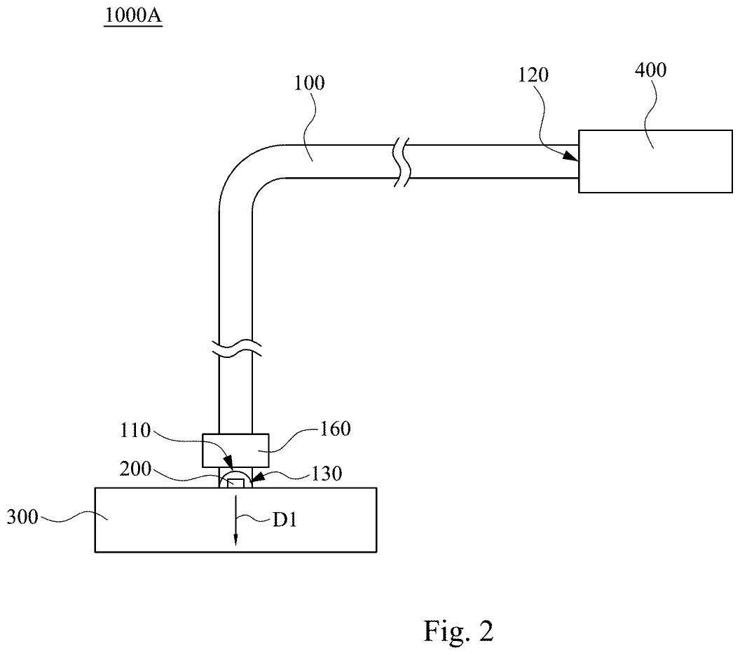

Reference is made to FIG. 2. FIG. 2 is a schematic cross-sectional view of an optical measurement system 1000A according to some embodiments of the present disclosure. In some embodiments, the optical measurement system 1000A further includes an alignment component 160 connected to the optical fiber 100 at a position between the first end 110 and the second end 120 compared to the optical measurement system 1000. The alignment component 160 is configured to maximize a power of the light received by the photo detecting component 400. In some embodiments, the alignment component 160 can be a precision motorized stage (e.g., with x-, y-, and z-axes), but should not be limited thereto. The alignment component 160 can be used to tune a position of the inner cavity 130 of the optical fiber 100 in order to accommodate the micro device 200 so as to maximize the power of the light received by the photo detecting component 400. Specifically, after the inner cavity 130 of the optical fiber 100 is roughly above the micro device 200, a position of the first end 110 of the optical fiber 100, especially a position of the inner cavity 130 is fine-tuned along the x- and y-axes to find a maximum power received by the photo detecting component 400, and then the z-axis is fine-tuned so that the inner cavity 130 fully covers and accommodates the micro device 200.

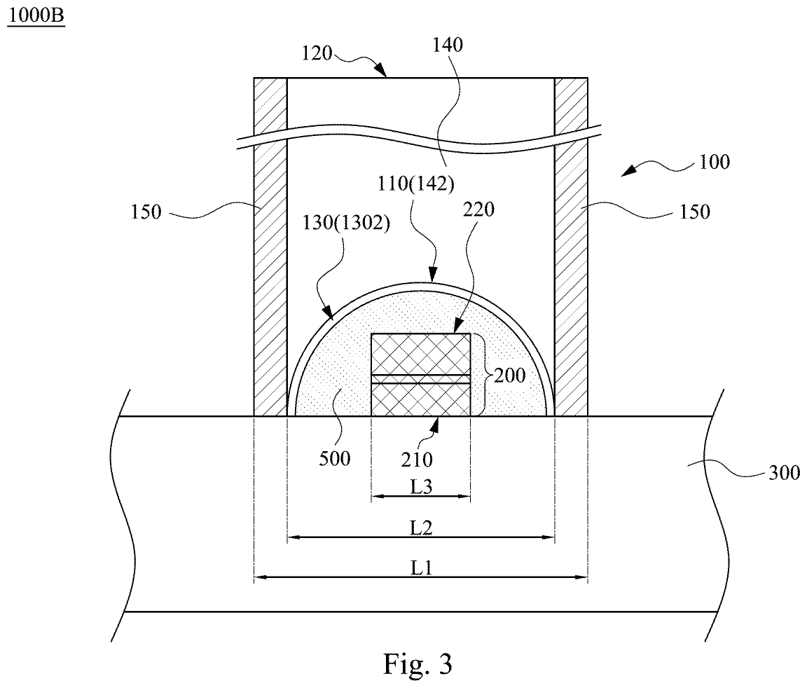

Reference is made to FIG. 3. FIG. 3 is a schematic enlarged cross-sectional view of a portion of an optical measurement system 1000B according to some embodiments of the present disclosure. In some embodiments, the optical measurement system 1000B further includes a transparent layer 500 in the inner cavity 130 and between the micro device 200 and the first end 110 when the micro device 200 is accommodated in the inner cavity 130 as compared to the optical measurement system 1000. In some embodiments, the transparent layer 500 is formed on the micro device 200. A refractive index of the transparent layer 500 is greater than 1. In some embodiments, the refractive index of the transparent layer 500 is smaller than a refractive index of the micro device 200. The transparent layer 500 can be used to enhance light collection from the micro device 200 to the core portion 140 since the transparent layer 500 decreases an amount of difference between the refractive index of the micro device 200 and a refractive index outside the micro device 200. There may be an air gap 1302 between the transparent layer 500 and the core portion 140 (see FIG. 3) or no air gap 1302 between the transparent layer 500 and the core portion 140 (e.g., the transparent layer 500 is in contact with the core portion 140). As a result, reflections and energy losses of light during propagating out from the micro device 200 can be reduced.

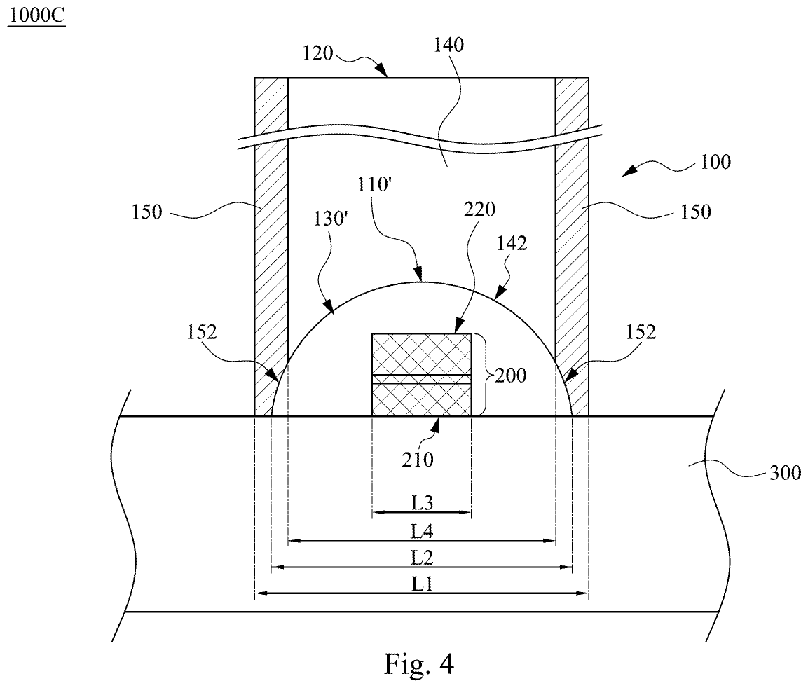

Reference is made to FIG. 4. FIG. 4 is a schematic enlarged cross-sectional view of a portion of an optical measurement system 1000C according to some embodiments of the present disclosure. In some embodiments, the cladding layer 150 has a curved surface 152 connected with the curved surface 142 of the core portion 140. Specifically, the first end 110′ of the optical fiber 100 is conformal to the curved surface 142 and the curved surface 152. In these embodiments, the inner cavity 130′ extends to some space originally occupied by the cladding layer 150. This kind of configuration may be helpful for the optical measurement system 1000C operated in a single-mode type. Specifically, for a single-mode type to be operated, a lateral length L4 (see FIG. 4) of the core portion 140 is restricted to be smaller than those allowed to be operated in multi-modes. In order to have enough space for the inner cavity 130′ to accommodate the micro device 200, the space included by the inner cavity 130′ is expanded to the space originally occupied by the cladding layer 150. In some embodiments, the inner cavity 130′ is defined by the core portion 140 and the cladding layer 150. In other words, a periphery of the inner cavity 130′ is formed by the curved surface 142 of the core portion 140 and the curved surface 152 of the cladding layer 150.

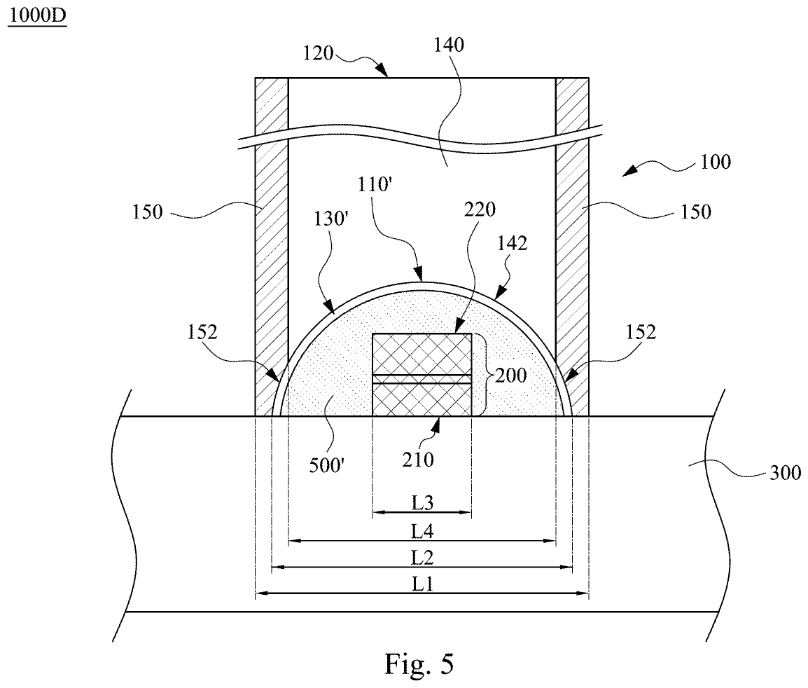

Reference is made to FIG. 5. FIG. 5 is a schematic enlarged cross-sectional view of a portion of an optical measurement system 1000D according to some embodiments of the present disclosure. In some embodiments, the optical measurement system 1000D further includes the transparent layer 500′ as compared to the optical measurement system 1000C as illustrated by FIG. 4. The function of the transparent layer 500′ is identical or similar to the transparent layer 500 of the embodiments of FIG. 3 and will not be repeated herein.

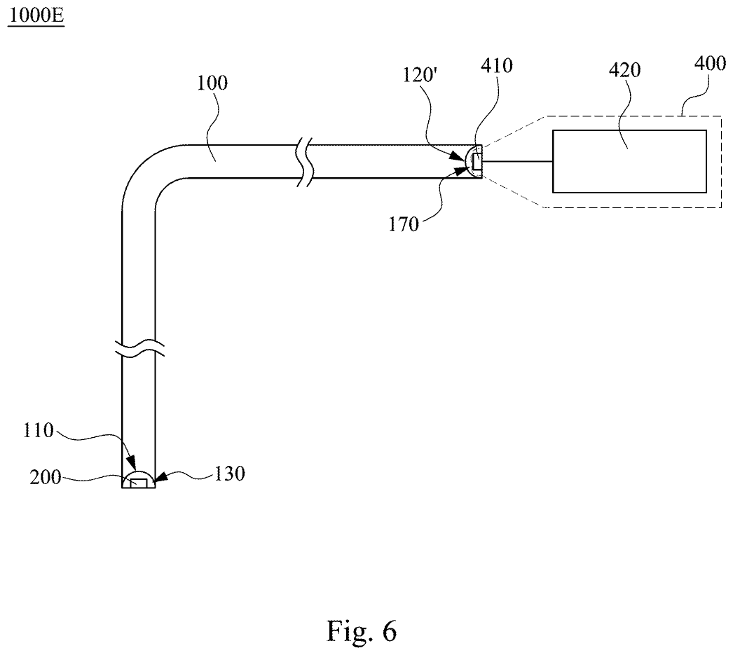

Reference is made to FIG. 6. FIG. 6 is a schematic cross-sectional view of an optical measurement system 1000E according to some embodiments of the present disclosure. In some embodiments, the photo detecting component 400 of the optical measurement system 1000E includes a photoelectric transducer 410. In some embodiments, the photo detecting component 400 of the optical measurement system 1000E includes an optical spectrometer 420. The photoelectric transducer 410 can be a photodiode or a phototransistor, but should not be limited thereto. The photoelectric transducer 410 is connected to the second end 120′ of the optical fiber 100. In some embodiments, another inner cavity 170 can be formed on the second end 120′ of the optical fiber 100 to accommodate the photoelectric transducer 410 so as to better receive light propagated in the optical fiber 100. In some embodiments, the another inner cavity 170 is recessed from the second end 120′. In some embodiments, a lateral length of the photoelectric transducer 410 is smaller than or equal to about 100 μm. In some embodiments, the photoelectric transducer 410 is connected to the optical spectrometer 420 so as to measure and analyze light received by the photoelectric transducer 410. In some embodiments, the optical spectrometer 420 measures light received by the photoelectric transducer 410 and analyzes it to get a “current-to-light output” curve and a full width at half maximum (FWHM) of a light spectrum emitted by the micro device 200 being measured so as to get more information on the quality of the micro device 200.

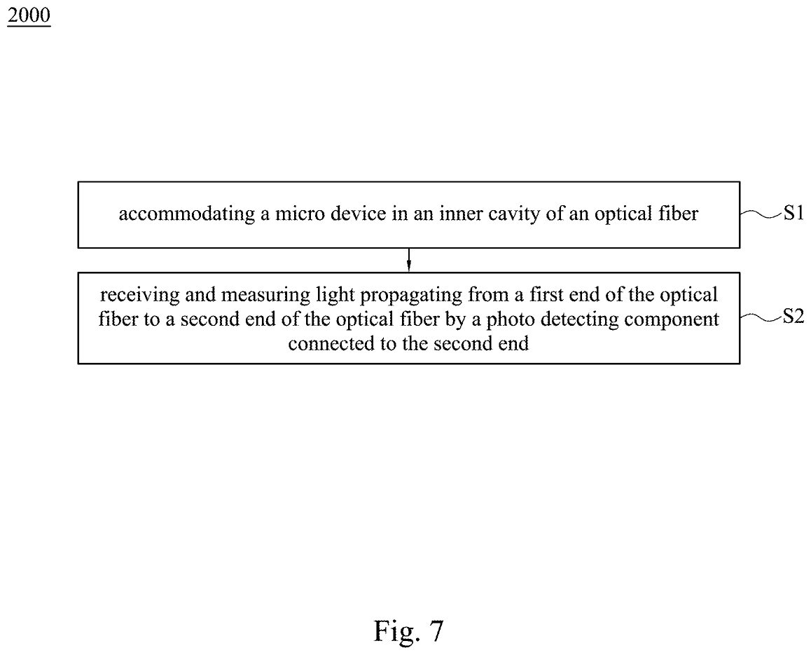

Reference is made to FIG. 7. FIG. 7 is a schematic flow chart of a method 2000 of measuring light emitted from the micro device 200. The method 2000 begins with operation S1 in which the micro device 200 is accommodated in the inner cavity 130(130′) of the optical fiber 100 in which the optical fiber 100 has the first end 110(110′) and the second end 120(120′) opposite to the first end 110(110′), and the inner cavity 130(130′) is recessed from the first end 110(110′). Specifically, the micro device 200 is covered by the optical fiber 100 such that the micro device 200 is substantially located within the inner cavity 130. The method 2000 continues with operation S2 in which the light propagating from the first end 110 to the second end 120 is received and measured by the photo detecting component 400 connected to the second end 120. Specifically, the light is propagated from the first end 110 to the second end 120 through the core portion 140 and is confined by the cladding layer 150. In some embodiments, the light is emitted from the micro device 200 and is received and measured by the photo detecting component 400. In some embodiments, a relative position among the optical fiber 100, the photo detecting component 400, and the micro device 200 is tuned to maximize the power of the light received by the photo detecting component 400 during operation S2. In some embodiments, said relative position is tuned by the alignment component 160 as mentioned, but should not be limited thereto. Specifically, after the inner cavity 130 of the optical fiber 100 is roughly above the micro device 200, a position of the first end 110 of the optical fiber 100, especially a position of the inner cavity 130 is fine-tuned along the x- and y-axes to find a maximum power received by the photo detecting component 400, and then the z-axis is fine-tuned so that the inner cavity 130 fully covers and accommodates the micro device 200.

In summary, embodiments of the present disclosure provide an optical measurement system and a method of measuring light emitted from a micro device in which an intensity of light emitted from a single micro device, which is smaller compared to an intensity of light emitted from a traditional device, can be efficiently measured by fully accommodating the single micro device into an inner cavity formed on one end of an optical fiber. The inner cavity is prepared to better collect light emitted from the single micro device and is able to enhance a signal to noise ratio received by a photo detecting component connected to another end of the optical fiber.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the method and the structure of the present disclosure without departing from the scope or spirit of the disclosure. In view of the foregoing, it is intended that the present disclosure cover modifications and variations of this disclosure provided they fall within the scope of the following claims.

What is claimed is:

1. An optical measurement system, comprising:
an optical fiber having a first end, a second end opposite to the first end, and an inner cavity recessed from the first end and configured to accommodate a micro device; and
a photo detecting component connected to the second end of the optical fiber and configured to receive light propagating from the first end of the optical fiber.

2. The optical measurement system of claim 1, wherein the photo detecting component comprises a photoelectric transducer.

3. The optical measurement system of claim 1, wherein the photo detecting component comprises an optical spectrometer.

4. The optical measurement system of claim 1, further comprising an alignment component connected to the optical fiber at a position between the first end and the second end and configured to maximize a power of the light received by the photo detecting component.

5. The optical measurement system of claim 1, further comprising a transparent layer in the inner cavity, wherein a refractive index of the transparent layer is greater than 1.

6. The optical measurement system of claim 1, wherein a lateral length of the optical fiber is greater than or equal to a lateral length of the inner cavity.

7. The optical measurement system of claim 1, wherein the optical fiber comprises:
a core portion; and
a cladding layer wrapping the core portion and configured to confine the light to propagate within the core portion.

8. The optical measurement system of claim 7, wherein a refractive index of the cladding layer is smaller than a refractive index of the core portion.

9. The optical measurement system of claim 7, wherein the core portion has a curved surface at the first end of the optical fiber, and the curved surface forms at least a part of the inner cavity.

10. The optical measurement system of claim 9, wherein a shape of the curved surface is hemispherical.

11. The optical measurement system of claim 9, wherein the cladding layer has a curved surface connected with the curved surface of the core portion.

12. The optical measurement system of claim 7, wherein the inner cavity is defined by the core portion and the cladding layer.

13. The optical measurement system of claim 1, further comprising another inner cavity recessed from the second end of the optical fiber.

14. A method of measuring light emitted from a micro device, comprising:
accommodating the micro device in an inner cavity of an optical fiber, the optical fiber having a first end and a second end opposite to the first end, and the inner cavity recessed from the first end; and
receiving and measuring light propagating from the first end to the second end by a photo detecting component connected to the second end.

15. The method of claim 14, further comprising:
tuning a relative position among the optical fiber, the photo detecting component, and the micro device to maximize a power of the light received by the photo detecting component.

16. The method of claim 14, wherein the optical fiber comprises:
a core portion; and
a cladding layer wrapping the core portion and configured to confine the light to propagate within the core portion.
